(19) United States
(12) Patent Application Publication
(10) Pub. No.: US 2025/0111810 A1
(43) Pub. Date: Apr. 3, 2025

(54) DISPLAY OF AUGMENTED REALITY IMAGES USING A VIRTUAL OPTICAL DISPLAY SYSTEM

(71) Applicant: ISRAEL AEROSPACE INDUSTRIES LTD., Lod (IL)

(72) Inventors: Yaacov TAVGER, Kiryat Arba (IL); Zeev GABBIN, Zafriya (IL)

(73) Assignee: ISRAEL AEROSPACE INDUSTRIES LTD., Lod (IL)

(21) Appl. No.: 18/721,420

(22) PCT Filed: Dec. 13, 2022
(86) PCT No.: PCT/IL2022/051319

§ 371 Date: Jun. 18, 2024

(30) Foreign Application Priority Data
Dec. 20, 2021 (IL) 289169

(51) Int. Cl. G09G 3/00; B60K 35/21; B60K 35/28; G02B 26/08; G02B 26/10; G02B 27/01; G06F 3/01

(52) U.S. Cl. CPC G09G 3/003; B60K 35/21; B60K 35/285; G02B 27/0101; G02B 27/0179; G06F 3/012; G06F 3/013; B60K 2360/177; B60K 2360/23; B60K 2360/333; B60K 2360/334; B60K 2360/741; G02B 26/0833; G02B 26/10; G02B 2027/014; G02B 2027/0187; G09G 2354/00; G09G 2380/10

(57) ABSTRACT

There is provided a system of displaying an augmented reality (AR) image on a viewable surface of a vehicle, the system comprising a processing circuitry configured to: receive data indicative of a location of a target external to the vehicle; determine a line-of-sight to the target in accordance with, at least, an operator viewing position and an operator viewing orientation; and control a scanning projector to display the AR image on a location of the viewable surface that is located substantially along the line-of-sight.

### TECHNICAL FIELD

The presently disclosed subject matter relates to aircraft image display systems, and in particular to display of augmented reality in such systems.

### BACKGROUND

Problems of implementation in systems for displaying guiding images in vehicles have been recognized in the conventional art and various techniques have been developed to provide solutions.

### GENERAL DESCRIPTION

According to one aspect of the presently disclosed subject matter there is provided a system of displaying an augmented reality (AR) image on a viewable surface of a vehicle, the system comprising a processing circuitry configured to:
a) receive data indicative of a location of a target external to the vehicle;
b) determine a line-of-sight to the target in accordance with, at least, an operator viewing position and an operator viewing orientation; and
c) control a scanning projector to display the AR image on a location of the viewable surface that is located substantially along the line-of-sight.

In addition to the above features, the method according to this aspect of the presently disclosed subject matter can comprise one or more of features (i) to (xvi) listed below, in any desired combination or permutation which is technically possible:
(i) the processing circuitry is configured to perform the controlling the scanning projector responsive to a difference between a viewing orientation and a line-of-sight angle that does not exceed an operator field-of-view threshold.
(ii) the operator viewing position is in accordance with, at least, a position of an operator's seat in a vehicle compartment.
(iii) the operator viewing orientation is in accordance with, at least, an assumed orientation of the operator's gaze.
(iv) the assumed orientation is towards the target.
(v) the assumed orientation is forward.
(vi) the operator viewing position is a head position that provided by an operator view-tracking subsystem in accordance with, at least, data from sensors mounted on an operator helmet.
(vii) the operator viewing position is a head position that provided by an operator view-tracking subsystem in accordance with, at least, data from cameras monitoring the operator's head.
(viii) the operator viewing orientation is a head orientation that provided by an operator view-tracking subsystem in accordance with, at least, data from cameras monitoring a direction of the operator's head.
(ix) the operator viewing orientation is a head orientation that provided by an operator view-tracking subsystem in accordance with data from cameras monitoring a direction of the operator's pupils.
(x) the processing circuitry is further configured to:
   d) receive additional data indicative of at least one of a set comprising:
      a. an updated location of the target,
      b. an updated operator viewing position, and
      c. an updated operator viewing orientation;
   e) determine an updated line-of-sight to the target; and
   f) further control the scanning projector to display the AR image on a location of the viewable surface that is located substantially along the updated line-of-sight.
(xi) the processing circuitry is further configured to control the scanning projector to display additional image data on the viewable surface.
(xii) additionally comprising the scanning projector, and wherein the scanning projector is operably connected to the processing circuitry, and is configured to display the AR image at infinity.
(xiii) the scanning projector comprises a laser.
(xiv) the scanning projector comprises one or more microelectromechanical system (MEMS) scanning mirrors configured to reflect light from the laser.
(xv) the scanning projector is suitable for displaying the AR image on a viewable surface that is a transparent windshield.
(xvi) the scanning projector is suitable for displaying the AR image on a viewable surface that is not flat.

According to a further aspect of the presently disclosed subject matter there is provided a processing circuitry-based method of displaying an augmented reality (AR) image on a viewable surface of a vehicle, the method comprising:
a) receiving data indicative of a location of a target external to the vehicle;
b) determining a line-of-sight to the target in accordance with, at least, an operator viewing position and an operator viewing orientation; and
c) controlling a scanning projector to display the AR image on a location of the viewable surface that is located substantially along the line-of-sight.

This aspect of the disclosed subject matter can further optionally comprise one or more of features (i) to (xvi) listed above with respect to the system, mutatis mutandis, in any desired combination or permutation which is technically possible.

According to another aspect of the presently disclosed subject matter there is provided a computer program product comprising a non-transitory computer readable storage medium retaining program instructions, which, when read by a processing circuitry, cause the processing circuitry to perform a method of displaying an augmented reality (AR) image on a viewable surface of a vehicle, the method comprising:
a) receiving data indicative of a location of a target external to the vehicle;
b) determining a line-of-sight to the target in accordance with, at least, an operator viewing position and an operator viewing orientation; and
c) controlling a scanning projector to display the AR image on a location of the viewable surface that is located substantially along the line-of-sight.

This aspect of the disclosed subject matter can further optionally comprise one or more of features (i) to (xvi) listed above with respect to the system, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1A illustrates a top view of an example utilization of a virtual optic display system, according to some embodiments of the presently disclosed subject matter;

FIG. 1B illustrates a top view of a second example utilization of a virtual optic display system, according to some embodiments of the presently disclosed subject matter;

FIG. 1C illustrates a side view of an example utilization of a virtual optic display system, according to some embodiments of the presently disclosed subject matter;

FIG. 2 illustrates a block diagram of an example beam controller of a virtual optic display system, according to some embodiments of the presently disclosed subject matter;

FIG. 3 illustrates an example flow diagram of a method of displaying an augmented reality image using a virtual optic display system, according to some embodiments of the presently disclosed subject matter;

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “determining”, “calculating”, “receiving”, “providing”, “obtaining”, “projecting”, “displaying” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

Aircraft can include a prior art navigation aid known as a head-up display (HUD). The HUD can be located—for example—in the cockpit, in front of the pilot and slightly above the pilot's head—so that the pilot looks up slightly to view it. The HUD system can include a projector which projects the image, a collimator (e.g. utilizing lenses) to create an image at infinity, and a transparent glass combiner to display the image. The HUD enables the pilot to view information, guiding images etc. thru the combiner, but is typically viewable only when the pilot is gazing forward (for example: within a range of 30 degrees).

In some embodiments of the presently disclosed subject matter, an aircraft or other vehicle includes a “virtual” optical display system. In some embodiments, the virtual optical display system utilizes a pixel-based scanning projector to create a guiding image on a windshield. In some embodiments, the scanning projector uses parallel beams, so that the image appears to the pilot to be located outside of the vehicle. In some embodiments, the image is displayed so that it appears to the pilot as on top of a target, as indicated by a line-of-sight from the head of the pilot to the target.

Among the advantages of some embodiments of the presently disclosed subject matter are that it provides ability to display the guiding image over a wider field of view (and not only the frontmost area of the aircraft), and a virtual guiding image at infinity without requiring a combiner or collimator (resulting in reduced cost).

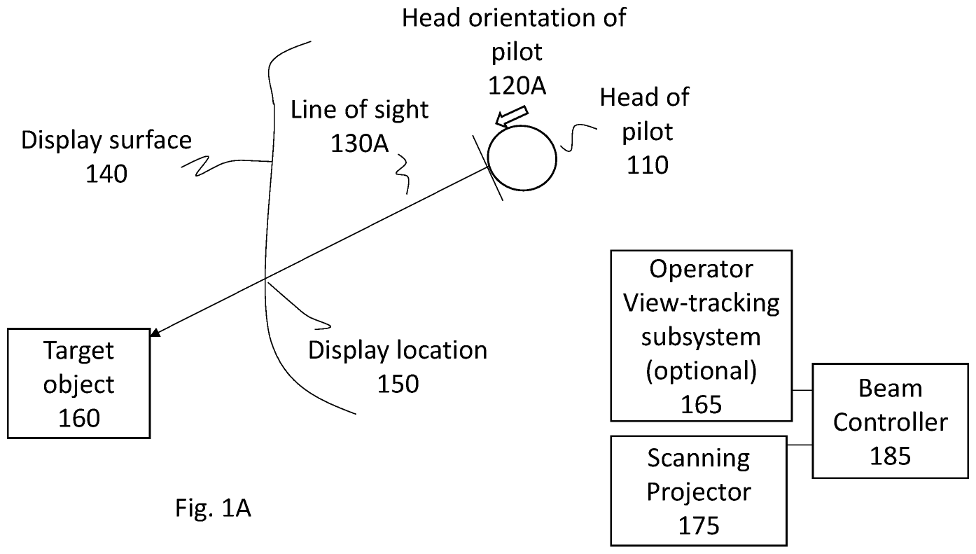

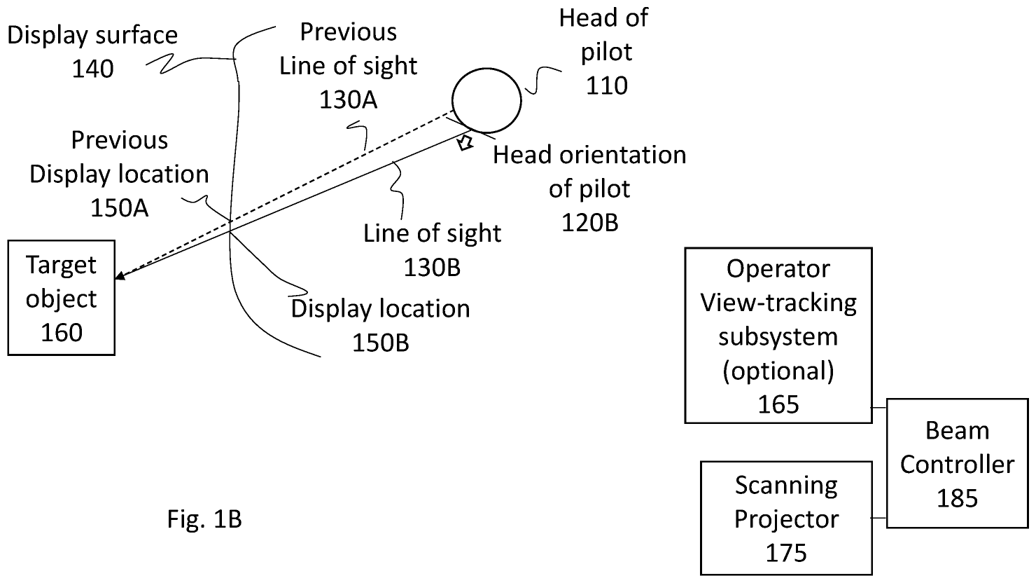

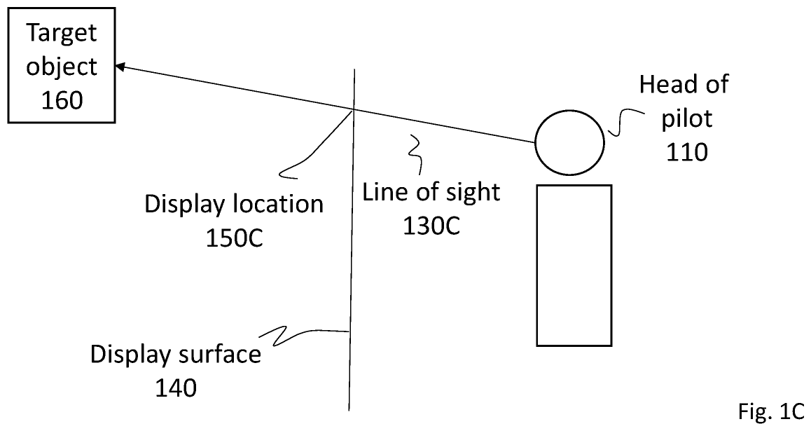

Attention is now directed to FIG. 1A, which depicts an overhead view of an example deployment of a virtual optical display system, in accordance with some embodiments of the presently disclosed subject matter.

Scanning projector 175 can be a device for projecting an image on display surface 140.

In some embodiments, scanning projector 175 includes a 2-dimensional (2D) scanner mirror. In some embodiments, scanning projector 175 includes a laser. In some embodiments, the laser of scanning projector 175 is configured to direct the laser's beam toward the mirror. In some embodiments, scanning projector 175 is configured to direct three laser beams (e.g., red, green, and blue) toward the mirror. In some such embodiments, scanning projector 175 includes or utilizes beam shaping, optics, or other mechanisms to render the beams directed toward the mirror as substantially parallel. In some embodiments, the 2D position of the mirror is controlled by a microelectromechanical system (MEMS)-based actuator, so that a controller can display a pixel at a particular display location by adjusting the mirror's position. In some embodiments, the controller can control modulation of the 2D scanner mirror, so as to control the pixel intensity. In some embodiments, the controller can repeatedly and cyclically adjust the 2D position of the mirror at high speed in order to display a pixel-based image (e.g., 1280×600 pixels) at a display location.

An example scanning projector is described in U.S. Pat. No. 9,769,444, “System and Method for Correcting Optical Distortions when projecting 2D images onto 2D surfaces”.

Scanning projector 175 can be installed at an appropriate location in a cockpit or vehicle compartment, so that it can project augmented reality (or other images) onto display surface 140. In some deployments, scanning projector 175 is attached to a supporting column of a cockpit.

Display surface 140 can be a transparent surface e.g. a windshield of a cockpit of an airplane or helicopter (or of a driver's compartment of a surface vehicle etc.). Alternatively, display surface 140 can be a non-transparent surface e.g. a wall of an armored vehicle.

Beam controller 185 can be a device (e.g. processor-based) for controlling scanning projector 175. Beam controller 185 can be operably connected to scanning projector 175 and can control the display location and the pixel content of an image displayed by scanning projector 175.

Beam controller 185 can receive data informative of the pilot's head position and head orientation from optional operator view-tracking subsystem 165. Beam controller 185 can maintain or receive information descriptive of the location of an airborne or ground-based target object 160. Target object 160 can be a moving or stationary tactical target located at some distance from the aircraft or vehicle.

Beam controller 185 can communicate with operator view-tracking subsystem 165 and scanning projector 175 via suitable interfaces (e.g., network connections). In some embodiments operator view-tracking subsystem 165 and/or scanning projector 175 can be integrated into beam controller 185.

A pilot (or other operator) can be located at a location inside the vehicle. The head of the pilot (or other operator) 110 can be in a particular orientation 120A e.g., the face of the pilot can be oriented toward a particular part of display surface 140.

Optional operator view-tracking subsystem 165 can be e.g., a processor-based device that measures the head position and/or head orientation 120 of the pilot (or operator) 110, and can supply the head position and/or orientation data to beam controller 185. In some embodiments, operator view-tracking subsystem 165 can determine head position and head direction by utilizing location sensors that are attached to the pilot's helmet.

In some other embodiments, operator view-tracking subsystem 165 utilizes sensors stationed in the cockpit or vehicle compartment that track the movement of the pilot's head or eyes. In some such embodiments, some or all of the sensors are cameras.

In some embodiments, beam controller 185 can control scanning projector 175, so as to mark or overlay the pilot's view of target object 160 with an augmented reality image (e.g. a weapons targeting guide). In some embodiments, beam controller 185 achieves accurate placement by displaying the augmented reality image on (or sufficiently close to) a line-of-sight 130A that originates from e.g. the head (or the eyes or pupils) of the pilot (or operator) and terminates at target object 160. Beam controller 185 can then control scanning projector 175 so as to display the augmented reality image e.g., at display location 150—where line-of-sight 130A meets display surface 140.

In some embodiments, beam controller 185 can control scanning projector 175 to additionally display images such as text or other information on display surface 140.

In some embodiments, scanning projector 175 projects the AR image using color beams that are substantially parallel. As a consequence, the pilot or operator viewing the image on display surface 140, perceives the AR image as being located at distant point external to the aircraft or vehicle (“virtual image at infinity”). This enables a pilot or operator to switch between viewing objects outside the aircraft or vehicle (e.g. target object 160) and viewing the AR image—without a need to refocus his/her vision.

In this manner, the need for a HUD can be obviated.

FIG. 1B illustrates an example where the pilot or operator 110 rotated to a new head direction 120B. The resulting line-of-sight 130B meets the display surface at a new display location 150B.

Attention is now directed to FIG. 1C, which depicts a side view of an example deployment of a virtual optical display system, in accordance with some embodiments of the presently disclosed subject matter. In this example, line-of-sight 130C extends from the head of the pilot (or operator) to target object 160, and meets display surface 140 at display location 150C.

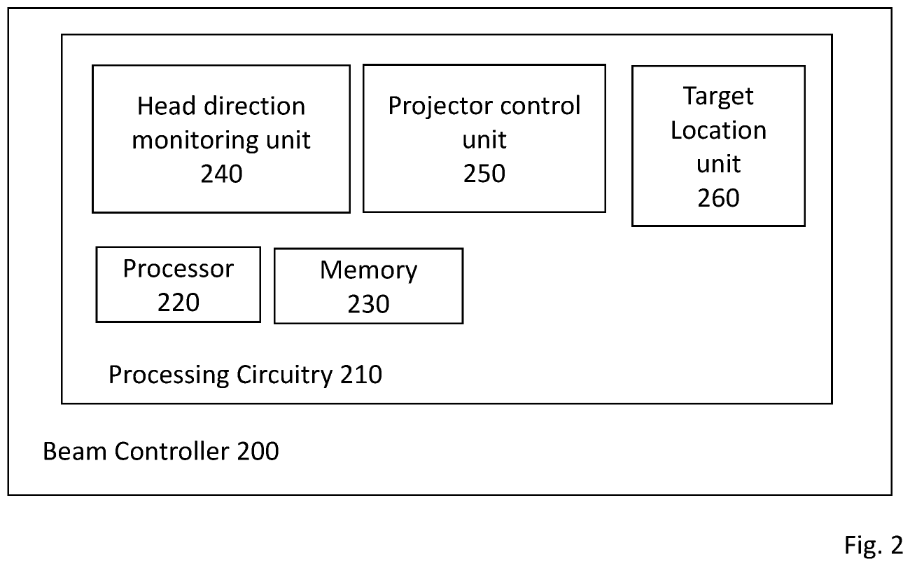

Attention is now directed to FIG. 2, which illustrates an example block diagram of a virtual optical display system, in accordance with some embodiments of the presently disclosed subject matter.

Beam controller 200 can include a processing circuitry 210. Processing circuitry 210 can include a processor 220 and a memory 230.

Processor 220 can be a suitable hardware-based electronic device with data processing capabilities, such as, for example, a general purpose processor, digital signal processor (DSP), a specialized Application Specific Integrated Circuit (ASIC), one or more cores in a multicore processor etc. Processor 220 can also consist, for example, of multiple processors, multiple ASICs, virtual processors, combinations thereof etc.

Memory 230 can be, for example, a suitable kind of volatile and/or non-volatile storage, and can include, for example, a single physical memory component or a plurality of physical memory components. Memory 230 can also include virtual memory. Memory 230 can be configured to, for example, store various data used in computation.

Processing circuitry 210 can be configured to execute several functional modules in accordance with computer-readable instructions implemented on a non-transitory computer-readable storage medium. Such functional modules are referred to hereinafter as comprised in the processing circuitry. These modules can include, for example, head direction monitoring unit 240, projector control unit 250, and target location unit 260.

Head direction monitoring unit 240 can determine the head position and/or head orientation of the pilot or operator of the aircraft or vehicle. In some embodiments, head direction monitoring unit 240 receives the head position (or data indicative of the head position) from operator view-tracking subsystem 165. In some embodiments, head direction monitoring unit 240 uses a fixed value for head position (for example: as determined from the location of the seat in the cockpit, and under the assumption that the pilot is facing forward). In some embodiments, head direction monitoring unit 240 uses another suitable method of determining the pilot's head position.

The pilot's head position can be given—for example—as x, y, and z coordinates denoting a location within the cockpit. The pilot's head orientation can be given as—for example—a signed rotation value (e.g. in degrees) indicating the rotation of the head from the facing forward position.

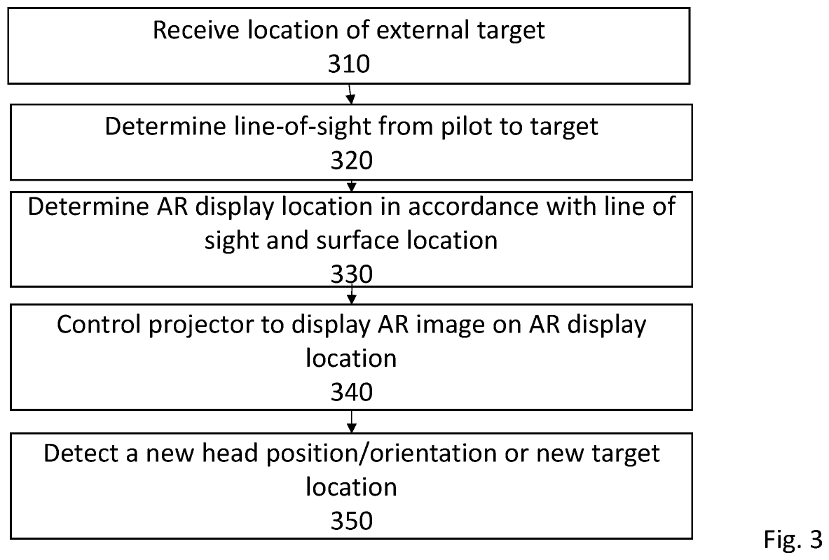

Projector control unit 260 can determine the display location on display surface 140 where the scanning projector 175 will display the AR image, and then control scanning projector 175 to display the image. An example method of determining the display location is described below, with reference to FIG. 3.

Target location unit 260 can determine the location of an external target for which the augmented reality image is to be applied. Target location unit 260 can determine the external target location from, for example, navigation and mapping systems within the aircraft. The external target location can be determined e.g. as an azimuth, elevation, and range relative to the aircraft in which the virtual optical display system is located. Target location unit 260 can alternatively determine the target location using a different suitable coordinate system or different suitable data.

It is noted that the teachings of the presently disclosed subject matter are not bound by the system described with reference to FIG. 2. Equivalent and/or modified functionality can be consolidated or divided in another manner and can be implemented in any appropriate combination of software with firmware and/or hardware and executed on a suitable device. Beam controller 200 can be a standalone entity, or integrated, fully or partly, with other entities.

Attention is now directed to FIG. 3, which depicts a flow diagram of an example method of displaying an augmented reality image using a virtual optical display system, in accordance with some embodiments of the presently disclosed subject matter.

For simplicity, the method is hereinbelow described in the context of a deployment located in an aircraft. It will be clear to one skilled in the relevant art how the teaching can be implemented in other types of deployments.

Processing circuitry 210 (for example: target location unit 260) can receive (310) the location of an external target to which the augmented reality image is to be applied. Processing circuitry 210 (for example: target location unit 260) can receive the external target location from, for example, navigation and mapping systems (not shown) within the aircraft. The external target location can be received as e.g., an azimuth, elevation, and range relative to the aircraft in which the virtual optical display system is located. Alternatively, processing circuitry 210 (for example: target location unit 260) can receive the target location as part of different suitable data or in a different suitable coordinate system.

Processing circuitry 210 (for example: head direction monitoring unit 240) can determine (320) a line-of-sight from the head of the pilot or operator of the aircraft to target object 160. For example: processing circuitry 210 (for example: head direction monitoring unit 240) can calculate a line-of-sight in accordance with i) a particular viewing position/viewing orientation associated with the pilot, and ii) the location of target object 160. For example: processing circuitry 210 (for example: head direction monitoring unit 240) can calculate the trajectory of a line projected from a particular pilot viewing position/viewing orientation to target object 160, as described above with reference to FIGS. 1A-1C.

In some embodiments, processing circuitry 210 (for example: head direction monitoring unit 240) receives the head position and head orientation (or data indicative of the head position and head orientation) from operator view-tracking subsystem 165. The head position can be given—for example—as x, y, and z coordinates denoting a location within the cockpit. The head orientation can be given—for example—a signed rotation value (e.g. in degrees) indicating the rotation of the head from the facing forward position, or in another suitable format.

Processing circuitry 210 (for example: head direction monitoring unit 240) can then—by way of non-limiting example—use the head position data and the head orientation data to compute a location of a single point that is to be utilized as the “viewing point”. This single point can be—for example—a particular point (or approximation) on the head of the pilot (e.g. a point between the eyes of the pilot). Processing circuitry 210 (for example: head direction monitoring unit 240) can then determine a line-of-sight by computing the trajectory from the “viewing point” to target object 160.

In some embodiments, processing circuitry 210 (for example: head direction monitoring unit 240) determines line-of-sight using the pilot's detected pupil location and orientation (i.e. gaze direction). In such embodiments, processing circuitry 210 (for example: head direction monitoring unit 240) can—by way of non-limiting example—use the pupil position data and the pupil gaze direction data to compute a location of a single point that is to be utilized as the “viewing point”. By way of non-limiting example: this single point can be computed by determining a particular point (or approximation) that would be between the eyes of the pilot if the pilot's head were rotated to face in the direction of the pupil gaze. With this method, in a case where the pupils are gazing forward this single point will be a point between the pupils. Processing circuitry 210 (for example: head direction monitoring unit 240) can then determine the line-of-sight by computing the trajectory from the “viewing point” to target object 160.

In some embodiments, processing circuitry 210 (for example: head direction monitoring unit 240) determines line-of-sight using fixed values instead of using a detected head position and head orientation. for head position. For example: processing circuitry 210 (for example: head direction monitoring unit 240) can utilize a known location of the operator's seat in the cockpit or vehicle compartment, and utilize an assumed orientation of the gaze of the pilot/operator e.g. a gaze that is directed forward, or alternatively a gaze that is directed toward target object 160). Processing circuitry 210 (for example: head direction monitoring unit 240) can then use these head position/head orientation values as the viewing position/viewing angle for calculating the line-of-sight.

An angle of trajectory of a line-of-sight to the target object 160 (given for example as a signed rotation value in degrees—relative to the orientation of operator in a facing-forward position) is herein termed the line-of-sight angle.

In some embodiments, processing circuitry (for example: head direction monitoring unit 240) uses another suitable method of calculating a line-of-sight in accordance with a viewing position/viewing orientation associated with the pilot, and the location of target object 160.

In some use scenarios, if the pilot's gaze is directed in a direction that is away from target object 160, the AR image could be distracting to the pilot (or otherwise undesirable). Accordingly, in some embodiments, a operator field-of-view threshold indicates a field-of-view (e.g. in degrees), within which the virtual optical display system displays the AR image. In such embodiments, if the pilot turns his gaze such that target object 160 is out of the indicated field of view, the virtual optical display system does not display the AR image (though the virtual optical display system may still display additional image data in accordance with the gaze direction).

In some such embodiments, the processing circuitry (for example: head direction monitoring unit 240) calculates the difference (e.g. in degrees) between the viewing orientation and the line-of-sight angle. In such embodiments, (for example: projector control unit 250) displays the AR image only if this calculated difference does not exceeding a static or dynamic operator field-of-view threshold (e.g. 30 degrees).

Processing circuitry 210 (for example: projector control unit 250) can next determine (330) the display location on display surface 140 for the AR image. This display location can be a place where the AR image provides optimum (or sufficient) enhancement to the pilot's view of the target.

Processing circuitry 210 (for example: projector control unit 250) can, for example, determine the display location in accordance with the location of the target object and the determined line-of-sight from the head of the pilot to target object 160. More specifically: processing circuitry 210 (for example: projector control unit 250) can select a point substantially proximate to where the line-of-sight meets display surface 140 for utilization as the display location. In some embodiments, processing circuitry 210 (for example: projector control unit 250) selects a point where the line-of-sight meets display surface 140. In this context, “substantially proximate” designates an area surrounding the point where the line-of-sight meets display surface 140, such that effective guidance is still provided to the pilot.

Processing circuitry 210 (for example: projector control unit 250) can then control (340) scanning projector 175 to display the AR image at the display location. In some embodiments, processing circuitry 210 (for example: projector control unit 250) displays the AR image (e.g. crosshairs) so that is appears directly on top of the pilot's view of target object 160. In some embodiments, processing circuitry (for example: projector control unit 250) controls scanning projector 175 to display the AR image (e.g. informative texts or symbols) adjacent to the pilot's view of target object 160. In some embodiments, processing circuitry (for example: projector control unit 250) controls scanning projector 175 to display the AR image in accordance with the pilot's view of target object 160, in a different manner. In some embodiments, processing circuitry (for example: projector control unit 250) controls scanning projector 175 to display additional image data (e.g. text pertaining to the speed and direction of the aircraft).

Processing circuitry 210 (for example: target location unit 260) can detect (350) a new target location. Alternatively, processing circuitry 210 (for example: head direction monitoring unit 260) can detect (350) a new viewer position or new viewer orientation (e.g. a new head position or new head orientation). In response to either of these events, processing circuitry 210 (for example: projector control unit 250) can return to calculate an updated line-of-sight and updated display location (and update the display of the AR image to the updated display location).

In some embodiments, processing circuitry 210 (for example: projector control unit 250) returns to calculate an updated display location only if the new viewer position differs from the previous viewer position by a distance meeting a static or dynamic viewer position difference threshold. In some embodiments, processing circuitry 210 (for example: projector control unit 250) returns to calculate an updated display location only if the new viewer orientation differs from the previous viewer orientation by a degree meeting a static or dynamic viewer orientation difference threshold

In some embodiments, processing circuitry 210 (for example: projector control unit 250) returns to calculate an updated display location only if the new target location differs from the previous target location by a distance meeting a static or dynamic target location difference threshold.

In some embodiments, processing circuitry 210 (for example: projector control unit 250) controls scanning projector 175 to display the AR image in an updated display location only if the difference between the updated display location and the previous display location meets a static or dynamic display location difference threshold.

It is noted that the teachings of the presently disclosed subject matter are not bound by the flow diagram illustrated in FIG. 3, and that in some cases the illustrated operations may occur concurrently or out of the illustrated order (for example, operations 340 and 350 can occur concurrently). It is also noted that whilst the flow chart is described with reference to elements of the system of FIGS. 1-2, this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A system of displaying an augmented reality (AR) image on a viewable surface of a vehicle,
the system comprising a processing circuitry comprising a processor and memory, the processing circuitry being configured to:
a) receive data indicative of a location of a target external to the vehicle;
b) determine a line-of-sight to the target in accordance with, at least, an operator viewing position and an operator viewing orientation; and
c) control a scanning projector to display the AR image on a location of the viewable surface that is located substantially along the line-of-sight.

2. The system of claim 1, wherein the processing circuitry is configured to perform the controlling the scanning projector responsive to a difference between a viewing orientation and a line-of-sight angle that does not exceed an operator field-of-view threshold.

3. The system of claim 1, wherein the operator viewing position is in accordance with, at least, a position of an operator's seat in a vehicle compartment.

4. The system of claim 1, wherein the operator viewing orientation is in accordance with, at least, an assumed orientation of the operator's gaze.

5. The system of claim 3, wherein the assumed gaze orientation is towards the target.

6. The system of claim 3, wherein the assumed gaze orientation is forward.

7. The system of claim 1, wherein the operator viewing position is a head position that provided by an operator view-tracking subsystem in accordance with, at least, data from sensors mounted on an operator helmet.

8. The system of claim 1, wherein the operator viewing position is a head position that provided by an operator view-tracking subsystem in accordance with, at least, data from cameras monitoring the operator's head.

9. The system of claim 1 wherein the operator viewing orientation is a head orientation that provided by an operator view-tracking subsystem in accordance with, at least, data from cameras monitoring a direction of the operator's head.

10. The system of claim 1 wherein the operator viewing orientation is a head orientation that provided by an operator view-tracking subsystem in accordance with data from cameras monitoring a direction of the operator's pupils.

11. The system claim 1, wherein the processing circuitry is further configured to:
d) receive additional data indicative of at least one of a set comprising:
a. an updated location of the target,
b. an updated operator viewing position, and
c. an updated operator viewing orientation;
e) determine an updated line-of-sight to the target; and
f) further control the scanning projector to display the AR image on a location of the viewable surface that is located substantially along the updated line-of-sight.

12. The system of claim 1, wherein the processing circuitry is further configured to control the scanning projector to display additional image data on the viewable surface.

13. The system of claim 1, additionally comprising the scanning projector, and wherein the scanning projector is operably connected to the processing circuitry, and is configured to display the AR image at infinity.

14. The system of claim 13, wherein the scanning projector comprises a laser.

15. The system of claim 14, wherein the scanning projector comprises one or more microelectromechanical system (MEMS) scanning mirrors configured to reflect light from the laser.

16. The system of claim 13, wherein the scanning projector is suitable for displaying the AR image on a viewable surface that is a transparent windshield.

17. The system of claim 13, wherein the scanning projector is suitable for displaying the AR image on a viewable surface that is not flat.

18. A processing circuitry-based method of displaying an augmented reality (AR) image on a viewable surface of a vehicle, the method comprising:
a) receiving data indicative of a location of a target external to the vehicle;
b) determining a line-of-sight to the target in accordance with, at least, an operator viewing position and an operator viewing orientation; and
c) controlling a scanning projector to display the AR image on a location of the viewable surface that is located substantially along the line-of-sight.

19. The method of claim 18, wherein the scanning projector is configured to display the AR image at infinity.

20. A computer program product comprising a non-transitory computer readable storage medium retaining program instructions, which, when read by a processing circuitry, cause the processing circuitry to perform a computerized method of displaying an augmented reality (AR) image on a viewable surface of a vehicle, the method comprising:
a) receiving data indicative of a location of a target external to the vehicle;
b) determining a line-of-sight to the target in accordance with, at least, an operator viewing position and an operator viewing orientation; and
c) controlling a scanning projector to display the AR image on a location of the viewable surface that is located substantially along the line-of-sight.
